(19) United States
(12) Patent Application Publication
(10) Pub. No.: US 2025/0371379 A1
(43) Pub. Date: Dec. 4, 2025

(54) METHOD OF MANAGING PERSONAL KNOWLEDGE GRAPH AND USER DEVICE USING THE METHOD

(71) Applicant: Samsung Electronics Co., Ltd., Suwon-si (KR)

(72) Inventors: Sungmok SEO, Suwon-si (KR); Jinhe JUNG, Suwon-si (KR); Kangyong PARK, Suwon-si (KR); Sangwoong PARK, Suwon-si (KR); Changhyup OH, Suwon-si (KR); Yunsu LEE, Suwon-si (KR); Hyunwoo JOO, Suwon-si (KR); Myunghee HAN, Suwon-si (KR)

(21) Appl. No.: 19/216,155

(22) Filed: May 22, 2025

Related U.S. Application Data
(63) Continuation of application No. PCT/KR2025/006446, filed on May 13, 2025.

(30) Foreign Application Priority Data
May 28, 2024 (KR) 10-2024-0069518

(51) Int. Cl. G06N 5/022

(52) U.S. Cl. CPC G06N 5/022

(57) ABSTRACT

A method performed by an electronic device for managing a personal knowledge graph is provided. The method includes detecting, by the electronic device, an instance including an incomplete node having missing knowledge property information in a personal knowledge graph, identifying, by the electronic device, candidate knowledge property information corresponding to the missing knowledge property information of the incomplete node, and performing, by the electronic device, a task of completing the incomplete node based on the identified candidate knowledge property information.

### CROSS-REFERENCE TO RELATED APPLICATION(S)

This application is a continuation application, claiming priority under 35 U.S.C. § 365 (c), of an International application No. PCT/KR2025/006446, filed on May 13, 2025, which is based on and claims the benefit of a Korean patent application number 10-2024-0069518, filed on May 28, 2024, in the Korean Intellectual Property Office, the disclosure of which is incorporated by reference herein in its entirety.

### TECHNICAL FIELD

The disclosure relates to a method of managing a personal knowledge graph and a user device using the method.

### BACKGROUND ART

Artificial intelligence (AI)-based technologies have been utilized in various fields across industries. Various AI models have been developed and utilized in various fields. Cases where AI-based solutions are applied to various industries, including manufacturing, robotics, transportation/logistics, medical treatment, education, or pharmaceutical/bio industries, are rapidly increasing. The introduction of such AI-based technologies leads to enhanced competitiveness for companies and countries.

To improve the performance of AI models, a knowledge base for AI model learning and AI model inference may be used. An example of the knowledge base is a knowledge graph that has a graph-type data structure. Interest in constructing and utilizing knowledge graphs is increasing.

The above information is presented as background information only to assist with an understanding of the disclosure. No determination has been made, and no assertion is made, as to whether any of the above might be applicable as prior art with regard to the disclosure.

### DISCLOSURE

### Technical Solution

An embodiment of the disclosure is to address at least the above-mentioned problems and/or disadvantages and to provide at least the advantages described below. Accordingly, an embodiment of the disclosure is to provide a method of managing a personal knowledge graph by performing a task of completing an incomplete node having missing knowledge property information in the personal knowledge graph and a user device using the method.

An embodiment of the disclosure will be set forth in part in the description which follows and, in part, will be apparent from the description, or may be learned by practice of the presented embodiments.

In accordance with an embodiment of the disclosure, a method performed by an electronic device for managing a personal knowledge graph is provided. The method includes detecting, by the electronic device, an instance including an incomplete node having missing knowledge property information in a personal knowledge graph, identifying, by the electronic device, candidate knowledge property information corresponding to the missing knowledge property information of the incomplete node, and performing, by the electronic device, a task of completing the incomplete node based on the identified candidate knowledge property information.

In accordance with an embodiment of the disclosure, an electronic device is provided. The electronic device includes memory comprising one or more storage media storing instructions, and one or more processors communicatively coupled to the memory, wherein the instructions, when executed by the one or more processors individually or collectively, cause the electronic device to detect an instance including an incomplete node having missing knowledge property information in a personal knowledge graph, identify candidate knowledge property information corresponding to the missing knowledge property information of the incomplete node, and perform a task of completing the incomplete node based on the identified candidate knowledge property information.

In accordance with an embodiment of the disclosure, one or more non-transitory computer-readable storage media storing one or more computer programs including computer-executable instructions that, when executed by one or more processors of an electronic device individually or collectively, cause the electronic device to perform operations are provided. The operations include detecting, by the electronic device, an instance including an incomplete node having missing knowledge property information in a personal knowledge graph, identifying, by the electronic device, candidate knowledge property information corresponding to the missing knowledge property information of the incomplete node, and performing, by the electronic device, a task of completing the incomplete node based on the identified candidate knowledge property information.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating an artificial intelligence (AI) platform based on a personal knowledge graph, according to an embodiment of the disclosure;

FIG. 2 is a diagram illustrating an operation performed by a user device to construct a knowledge graph-based personalized database, according to an embodiment of the disclosure;

FIGS. 3A and 3B are diagrams illustrating a content ontology as an example of ontology used by a user device to construct a personal knowledge graph, according to an embodiment of the disclosure;

FIG. 4 is a diagram illustrating an operation performed by a user device to provide a personal knowledge graph-based service to a user, according to an embodiment of the disclosure;

FIGS. 5A, 5B, and 5C are diagrams illustrating a process performed by a user device to search for a photo by using a search term based on knowledge property information through a personal knowledge graph-based search application, according to an embodiment of the disclosure;

FIG. 6 is a diagram illustrating an operation performed by a user device to manage a personal knowledge graph, according to an embodiment of the disclosure;

FIG. 7 is a flowchart showing a method of managing a personal knowledge graph, according to an embodiment of the disclosure;

FIG. 8 is a diagram illustrating an instance including a complete node and an instance including an incomplete node having missing knowledge property information according to a certain class in a personal knowledge graph, according to an embodiment of the disclosure;

FIG. 9 is a diagram illustrating various types of embedding vectors used to infer candidate knowledge property information corresponding to missing knowledge property information, according to an embodiment of the disclosure;

FIG. 10 is a diagram illustrating a process of performing a task of completing an incomplete node by replacing the incomplete node with a complete node, according to an embodiment of the disclosure;

FIG. 11 is a diagram illustrating a process of performing a task of completing an incomplete node by updating missing knowledge property information of an incomplete node with candidate knowledge property information identified in a complete node, according to an embodiment of the disclosure;

FIG. 12 is a block diagram illustrating a user device according to an embodiment of the disclosure; and

FIG. 13 is a block diagram illustrating a configuration and an operation of a user device according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As for the terms as used in the disclosure, common terms that are currently widely used are selected as much as possible while taking into account the functions in the disclosure. However, the terms may vary depending on the intention of those of ordinary skill in the art, precedents, the emergence of new technology, and the like. Also, in a particular case, there are also terms arbitrarily selected by the applicant. In this case, the meaning of the terms will be described in detail in the description of the disclosure. Therefore, the terms as used herein should be defined based on the meaning of the terms and the description throughout the disclosure rather than simply the names of the terms.

All terms including technical or scientific terms as used herein have the same meaning as commonly understood by those of ordinary skill in the art. It will be understood that although the terms “first,” “second,” etc. may be used to describe various elements, these elements should not be limited by these terms. These terms are only used to distinguish one element from another.

Throughout the specification, the expression “a portion includes a certain element” means that the portion further includes other elements rather than excludes other elements unless otherwise stated. Also, the terms such as “unit” and “module” described in the specification mean units that process at least one function or operation, and may be implemented as hardware, software, or a combination of hardware and software.

The functions related to artificial intelligence (AI) according to the disclosure are operated through a processor and memory. The processor may be implemented as one or more processors. At this time, the one or more processors may be a general-purpose processor, such as a central processing unit (CPU), an application processor (AP), or a digital signal processor (DSP), a dedicated graphics processor, such as a graphics processing unit (GPU) or a vision processing unit (VPU), or a dedicated AI processor, such as a neural processing unit (NPU). The one or more processors may perform control to process input data according to an AI model or a predefined operation rule stored in the memory. Alternatively, when the one or more processors are dedicated AI processors, the dedicated AI processors may be designed with a hardware structure specialized for processing a specific AI model.

The AI model and the predefined operation rule are made through learning. The expression “being made through learning” means that the AI model or the predefined operation rule configured to perform desired characteristics (or purposes) is made in such a manner that a basic AI model is trained by using a large number of training data by a learning algorithm. The learning may be accomplished in a device itself that performs AI according to the disclosure, or may be accomplished through a separate server and/or system. Examples of the learning algorithm include supervised learning, unsupervised learning, semi-supervised learning, or reinforcement learning, but the disclosure is not limited to the examples described above.

The AI model may include a plurality of neural network layers. Each of the neural network layers has a plurality of weight values and performs neural network operations through operations between the plurality of weight values and an operation result of a previous layer. The weight values of the neural network layers may be optimized by a training result of the AI model. For example, the weight values may be updated so that a loss value or a cost value obtained by the AI model during a training process is reduced or minimized. An artificial neural network may include a deep neural network (DNN), a convolutional neural network (CNN), a recurrent neural network (RNN), a restricted Boltzmann machine (RBM), a deep belief network (DBN), a bidirectional recurrent deep neural network (BRDNN), or deep Q-networks, etc., but the disclosure is not limited to the examples described above.

In the disclosure, a “knowledge graph” is a method of managing and searching for knowledge information and refers to a graph-structured knowledge base based on a knowledge base that stores knowledge information and a graph that expresses knowledge information so as to be analyzed in a network structure. The knowledge graph is a graph model that implements knowledge accumulated in the knowledge base as a relationship between nodes and edges. The knowledge graph may be used to integrate data by using graph data models, topologies, etc. To enable knowledge to be interconnected and integrated by using a knowledge graph, a schema is implemented through ontology, and a structure and dictionary (terminology) that may be shared with each other are used.

Semantic information including commonsense and fact knowledge is organized as connections between nodes and edges, and various types of data may be converted into the form of a knowledge graph with reference to the semantic information. As a method of expressing a knowledge graph, a labeled property graph (LPG) in which a node and an edge each have properties, a resource description framework (RDF) that expresses a relationship in a triple structure of subject-predicate-object, etc. may be used, but the disclosure is not limited thereto. The knowledge graph may be generated by recognizing entities from various data, performing linking (entity linking) to appropriate entities in an existing knowledge base, and extracting a relationship between the entities.

The knowledge graph may be used to improve the performance of AI. The knowledge graph may be used in models, such as a graph neural network (GNN) or a graph convolution neural network (GCN), and may be used to provide a description of a result in explainable AI (XAI).

Hereinafter, an embodiment of the disclosure will be described in detail with reference to the accompanying drawings, so that those of ordinary skill in the art may easily carry out the disclosure. However, the disclosure may be implemented in various different forms and is not limited to the embodiment of the disclosure described herein.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like. Hereinafter, the disclosure is described in detail with reference to the accompanying drawings.

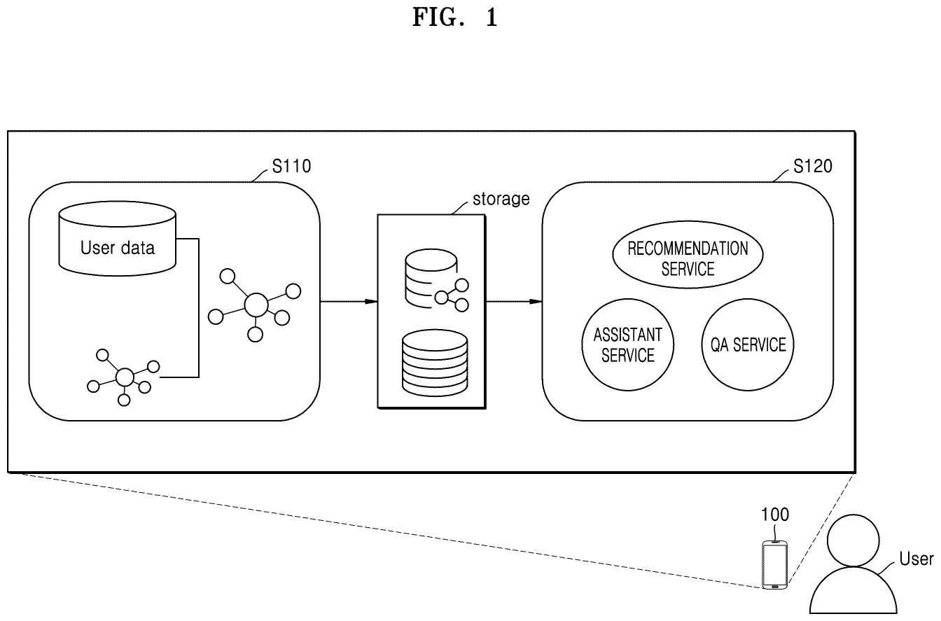

FIG. 1 is a diagram illustrating an AI platform based on a personal knowledge graph, according to an embodiment of the disclosure.

Referring to FIG. 1, the AI platform based on the personal knowledge graph is provided to a user by a process of constructing a knowledge graph-based personalized database (S110) and a process of providing a personalized AI service to a user through a knowledge graph-based service application (S120).

In the process of constructing the knowledge graph-based personalized database (S110), a user device 100 may generate a personal knowledge graph of a standardized form with reference to a general knowledge graph of a standardized form, such as commonsense and fact knowledge, by using user data obtained by the user device 100. The user device 100 may convert various types of unstructured data into the form of a knowledge graph, construct a knowledge graph-based personalized database, i.e., a personal knowledge graph, and store the personal knowledge graph in a storage.

In the process of providing the personalized AI service to the user through the knowledge graph-based service application (S120), the user device 100 may provide various services by using the personalized database stored in the storage, i.e., the personal knowledge graph. The user device 100 may provide a recommendation service, an assistant service, a question answering (QA) service, etc. by using the personal knowledge graph.

For example, when an action is performed by the user, the user device 100 may use the recommendation service to recommend music that the user enjoys listening to while performing the action or may use the assistant service to provide knowledge information based on the personal knowledge graph as well as information about related past experiences or upcoming events (e.g., calendar schedules). The user device 100 may identify a user's behavioral pattern from the personalized database, and when the user exhibits a pattern that is different from a usual behavioral pattern, the user device 100 may use the recommendation service to provide a solution service related to the cause of the different pattern. The user device 100 may use the QA service to provide a customized answer to a user's question, based on the personalized database. The user device 100 may use the assistant service to perform a journaling function to manage and describe a user's daily work or special event, etc. by using the personalized database.

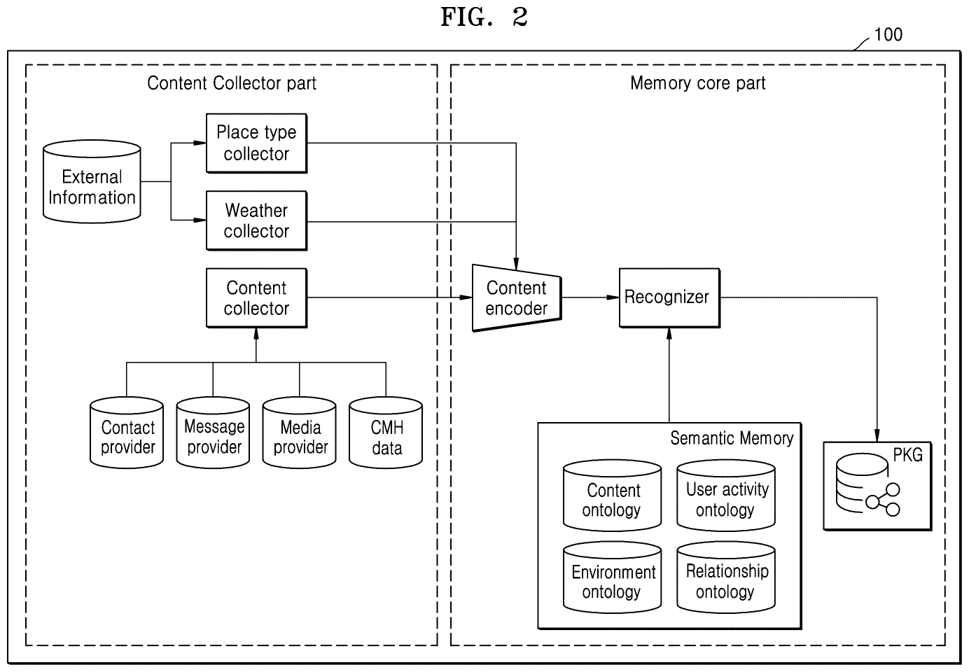

FIG. 2 is a diagram illustrating an operation performed by the user device 100 to construct a knowledge graph-based personalized database, according to an embodiment of the disclosure.

The user device 100 according to an embodiment of the disclosure may be an electronic device capable of processing data. For example, the user device 100 may be an electronic device, such as a smartphone, smart glasses, a wearable device, a digital camera, a laptop, an augmented reality (AR) device, or a virtual reality (VR) device. Various types of neural network models may be mounted on the user device 100. For example, at least one of models, such as a CNN, a GCN, a GNN, a DNN, an RNN, or a BRDNN, may be mounted on the user device 100, and a combination thereof may be used.

The user device 100 according to an embodiment of the disclosure may convert various types of unstructured data into the form of a knowledge graph and construct a knowledge graph-based personalized database. The user device 100 may obtain various types of data and convert the data into triple format data. The user device 100 may map the converted data to ontology stored in semantic memory and reflect standardized information matching the ontology format to the personal knowledge graph. The ontology is a type of dictionary that defines terms conceptualizing data and a relationship between the terms. The ontology may be expanded by converting external knowledge into triple format data and adding the triple format data.

The data obtained by the user device 100 according to an embodiment of the disclosure may be metadata for content, such as text, photos, videos, or music, which is collected by the user device 100. The data obtained by the user device 100 may be those stored in the user device 100 in the form of metadata about the application used or metadata about event occurrence time, place, weather, etc. The data obtained by the user device 100 may include at least one of data input from the user through the user device 100, data sensed by the user device 100, external data received by the user device 100, or data processed by the user device 100.

The user device 100 may process unstructured data obtained by the user device 100 into structured information and store the structured information in the personal knowledge graph. The user device 100 may previously prepare semantic information of a standardized form in the semantic memory as ontology. By referring to semantic information of various types of ontologies stored in the semantic memory, the user device 100 may process unstructured data obtained by the user device 100 into structured information and store the structured information in the personalized database. For example, the user device 100 may convert various types of unstructured data into the form of a knowledge graph and store the knowledge graph in the personal knowledge graph.

FIG. 2 illustrates an example of a process performed by the user device 100 to collect metadata about content generated or provided by the user device 100 and construct a personalized database in the form of a knowledge graph. For detailed explanation, an example of a process of constructing a personal knowledge graph based on user content is described with reference to FIG. 2, but the disclosure is not limited thereto and may be applied to other types of personal knowledge graphs.

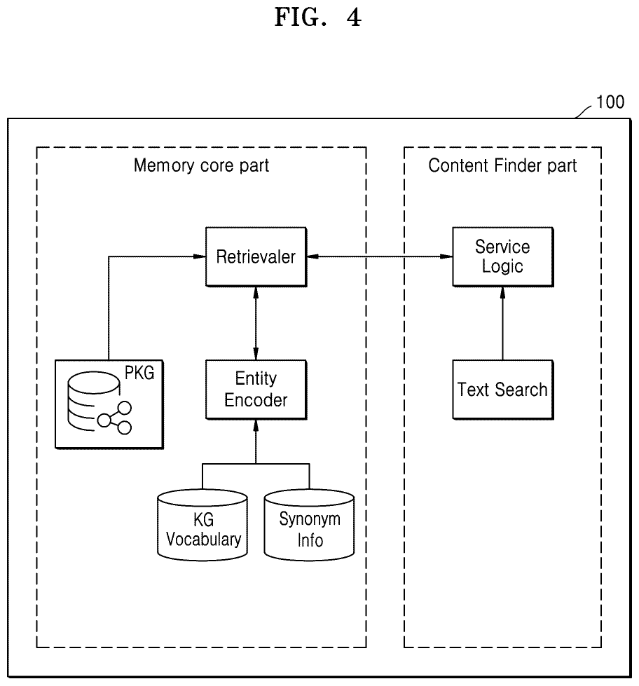

In the user device 100, a content collector of a content collector part may collect metadata about content from a contact provider, a message provider, a media provider, content management hub (CMH) data, etc. The content collector is not limited to the example illustrated in FIG. 4 and may collect metadata from various types of applications installed on the user device 100. The content collector may include a postprocessing module that classifies character types, parses text, classifies image types, and recognizes objects within images. A place type collector and a weather collector may collect metadata about a place or a weather from external information obtained by the user device 100.

In the user device 100, a content encoder of a memory core part may convert the metadata about the content and the metadata corresponding to the place or the weather related to the content into triple format data. A recognizer may map the triple format data to ontology stored in semantic memory, infer standardized information matching an ontology format, and reflect the inferred standardized information to the personal knowledge graph. As illustrated in FIG. 2, various types of ontologies, such as content ontology, user activity ontology, environment ontology, or relationship ontology, may be previously prepared in the semantic memory according to the purpose, and the recognizer may integrate various ontologies prepared in the semantic memory and perform searching.

Referring to FIG. 2, a process performed by the user device 100 to construct the personal knowledge graph based on user content by collecting metadata about content generated or provided by the user device 100, convert the collected metadata into a triple format, and then map the triple format metadata to the content ontology is illustrated as an example of constructing the knowledge graph-based personalized database. The personal knowledge graph based on the user content may use nodes and edges to represent instances of content collected by using photos or videos owned by the user, message information transmitted and received by the user, or contact information. For example, the message provider and the media provider may transmit, to the content encoder, card payment information received on January 1 and data about a photo taken on January 1, which are received by the user device 100. The transmitted data may be linked to the ontology of the personal knowledge graph as an instance of an event that occurred on January 1 through text and metadata analysis.

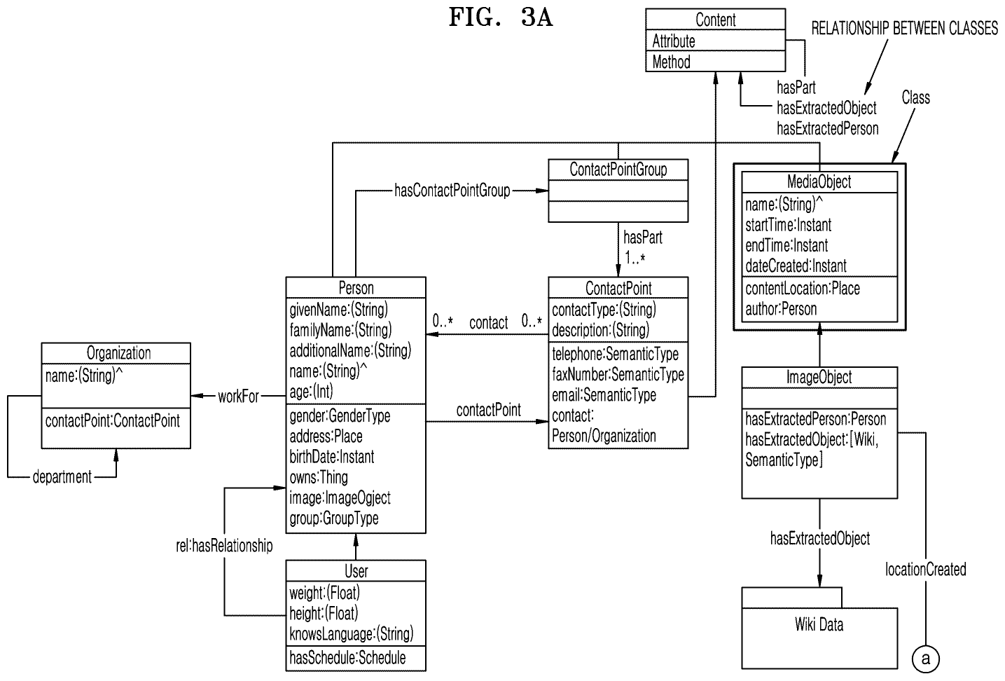

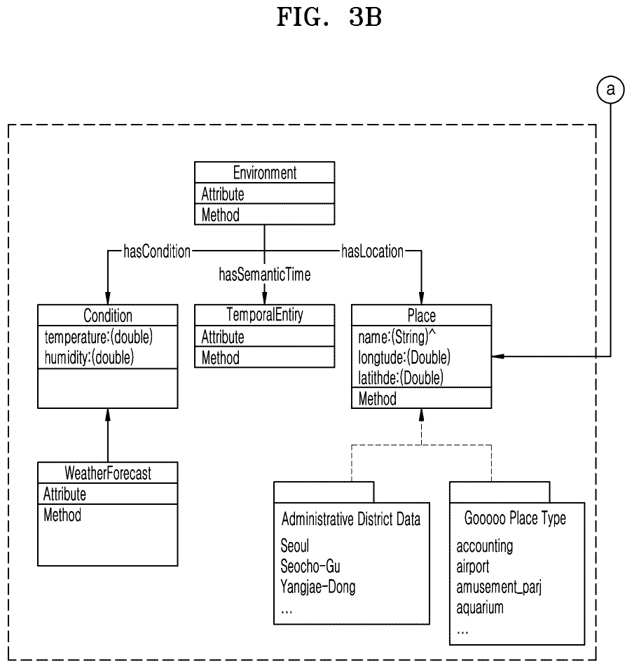

FIGS. 3A and 3B are diagrams illustrating the content ontology as an example of the ontology used by the user device 100 to construct the personal knowledge graph, according to an embodiment of the disclosure.

As described above, in the process of constructing the personal knowledge graph based on the user content, the user device 100 may generate data of a standardized form matching the ontology format by collecting metadata about content generated or provided by the user device 100, converting the collected metadata into a triple format, and then mapping the converted data to the content ontology stored in the semantic memory. At this time, the content ontology may be used in the process of constructing the personal knowledge graph based on the user content.

FIGS. 3A and 3B illustrate an example of the content ontology. The content ontology may be used to model content that a user consumes. The content ontology defines data items that may be collected for each type of content, and this is referred to as a “class.” The content ontology may include nodes corresponding to the respective classes and edges expressing a relationship between the respective classes, and sub-classes may inherit properties of super-classes. An instance is data items defined in a class through data collection and to which actual data values are applied, and each data item becomes knowledge property information of the instance. The instance may be generated to correspond to each class on the ontology. For example, in the case of the content ontology of FIGS. 3A and 3B, an instance corresponding to the highest level content may be generated, and a lower level instance, such as a person or an environment, may be generated. Actual data values may be recorded on the knowledge property information of the instance, or actual data values may be recorded on data items predefined with reference to classes of the same or different types of ontology. For example, in a media object illustrated in FIGS. 3A and 3B, actual data values matching data types may be recorded on data items, such as name, start time, end time, or creation date. In addition, in the media object, actual data values may be recorded according to data items defined in a “place” class of an environment ontology for a data item of a content location. In addition, in the media object, actual data values may be recorded according to data items defined in a “person” class of a content ontology for a data item of an author.

Collectable data items may be predefined in the class so that pieces of information remembered together when the user remembers content become knowledge property information of each instance in the personal knowledge graph based on the user content. When all data values for data items defined in the class are collected from various metadata related to the content without omission, the user device 100 may provide a user-friendly content search according to a method that the user remembers, by using a query including the knowledge property information and the personal knowledge graph based on the user content. When metadata about some objects constituting the content are missing or when some metadata about a certain object are missing, some values of knowledge property information of the instance of the corresponding content may be missing or empty, and thus, the user device 100 may not be able to search for the content.

The user device 100 according to an embodiment of the disclosure may model user content through user modeling-based data collection using the content ontology. For example, the user device 100 may use the content ontology to obtain data of a standardized form matching an ontology format with respect to photos stored in the user device 100 and generate the personal knowledge graph based on the user content.

FIG. 4 is a diagram illustrating an operation performed by the user device 100 to provide a personal knowledge graph-based service to a user, according to an embodiment of the disclosure.

The user device 100 according to an embodiment of the disclosure my provide a personalized service to a user through a personal knowledge graph-based service application. The user device 100 may construct a knowledge graph-based personalized database.

FIGS. 2, 3A, and 3B are knowledge graph-based personalized databases, and the following description is given on the assumption that a personal knowledge graph is constructed based on user content. An embodiment of the disclosure in which the user device 100 provides a content search service by using a query including a search term input by a user and a personal knowledge graph based on user content is described below, but the disclosure is not limited to such a service.

According to an embodiment of the disclosure, a service logic module included in in a content finder part of the user device 100 may execute a content search service to receive a user input regarding a search term. The service logic module may transmit the search term input by the user to a retrievaler. A text search module may transmit a result of performing simple text matching on the search term to the service logic module. The service logic module may provide search results based on results of collating text matching results and query results for the personal knowledge graph based on the user content and may apply rankings to the search results.

In the memory core part of the user device 100, the retrievaler may derive an internationalized resource identifier (IRI) of the search term transmitted from the service logic module through the entity encoder. An entity encoder may support multilingual processing or synonym processing with respect to the search term by using a knowledge graph vocabulary database and a synonym database to convert the search term into a standard language registered in the knowledge graph and derive an IRI corresponding to the search term. The retrievaler may construct a query using the IRI corresponding to the search term and receive a query result for the personal knowledge graph based on the user content. The query result for the personal knowledge graph based on the user content may include a list of IRIs of content related to the IRIs included in the query, knowledge property information of each content, type information or score information of the knowledge property information, type information of the content, etc. The knowledge property information of each content may be preset up to knowledge property information of an n-hop relationship with the content. The type information of the knowledge property information may be data item information (field information) predefined in a class when configuring the content ontology or separate type information defined for each node of each content. The retrievaler may output a related search term based on the knowledge property information and/or the type information of the knowledge property information together with the search result based on the query result.

When the user input regarding the search term is a multisearch term, the service logic module may transmit the multisearch term input by the user to the retrievaler. The case of a search using a multisearch term may include a case where a first search term and a second search term are input at the same time and a case where a second search term is additionally input after a first search term is input.

In an embodiment of the disclosure, when the first search term and the second search term are input at the same time, the retrievaler may derive an IRI corresponding to the first search term and an IRI corresponding to the second search term through the entity encoder. The retrievaler may construct a query using the IRI corresponding to the first search term and a query using the IRI corresponding to the second search term, receive results of the respective queries, and obtain a final result corresponding to the intersection (or union) of the results of the respective queries.

In an embodiment of the disclosure, when the second search term is additionally input after the first search term is input, the retrievaler may store, in a cache, a query result of the query using the IRI corresponding to the first search term. When the second search term is additionally input, the retrievaler may obtain a final result of the multisearch term by deriving the IRI corresponding to the second search term and filtering the query result stored in the cache by using the IRI corresponding to the second search term. When the cache is used for the search using the multisearch term, a method of filtering the query result stored in the cache may be expected to obtain a fast response, compared to a method of performing the intersection of two query results.

When the user input regarding the search term is a multisearch term using operation symbols, the service logic module may transmit, to the retrievaler, the multisearch term using operation symbols input by the user. The retrievaler may parse the multisearch term using operation symbols and separately process the first search term, the operation symbols, and the second search term. The retrievaler may perform a predefined operation on a first query result of the query using the IRI corresponding to the first search term and a second query result of the query using the IRI corresponding to the second search term according to the type of the operation symbol. For example, when the operation symbol is “+,” a result of integrating the first query result and the second query result may be output. When the operation symbol is “−,” a result of removing the second query result from the first query result may be output. When inputting the multisearch term, at least one operation symbol may be used, parentheses may be input, and operation symbols corresponding to operations defined by the user may be used.

On the other hand, when the instance corresponding to the search term input by the user is not present in the personal knowledge graph, it is possible to preset whether to output a query result for an instance corresponding to a higher class than a class of the instance corresponding to the search term. Furthermore, node information may be collected from a knowledge graph of an external server by using class information of the instance corresponding to the search term, a related search term in which the instance is present may be extracted in conjunction with a personal knowledge graph, and then, a search result may be provided. Furthermore, ontology including the class information of the instance corresponding to the search term may be downloaded from the external server, a related search term in which the instance is present may be extracted in conjunction with a personal knowledge graph, and then, a search result may be provided.

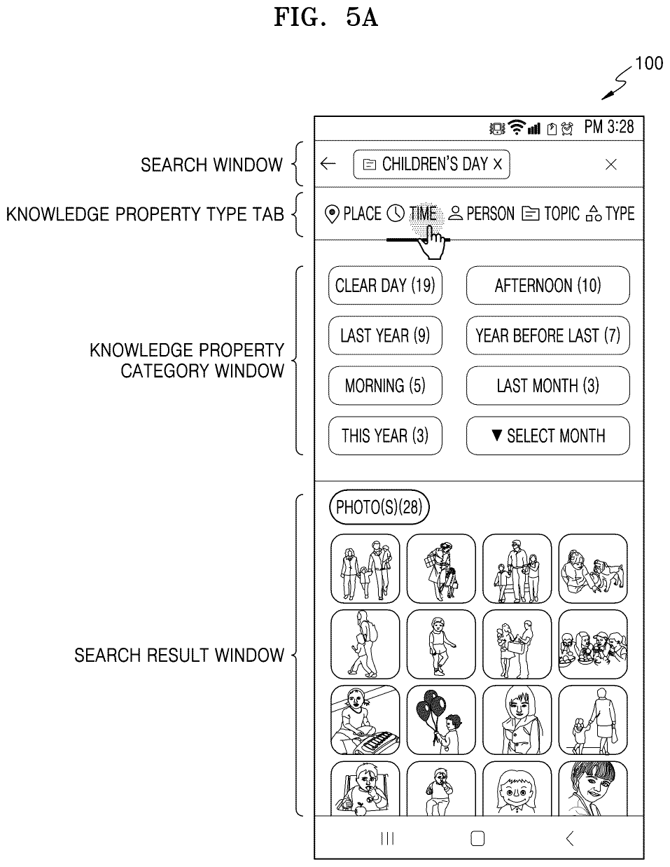

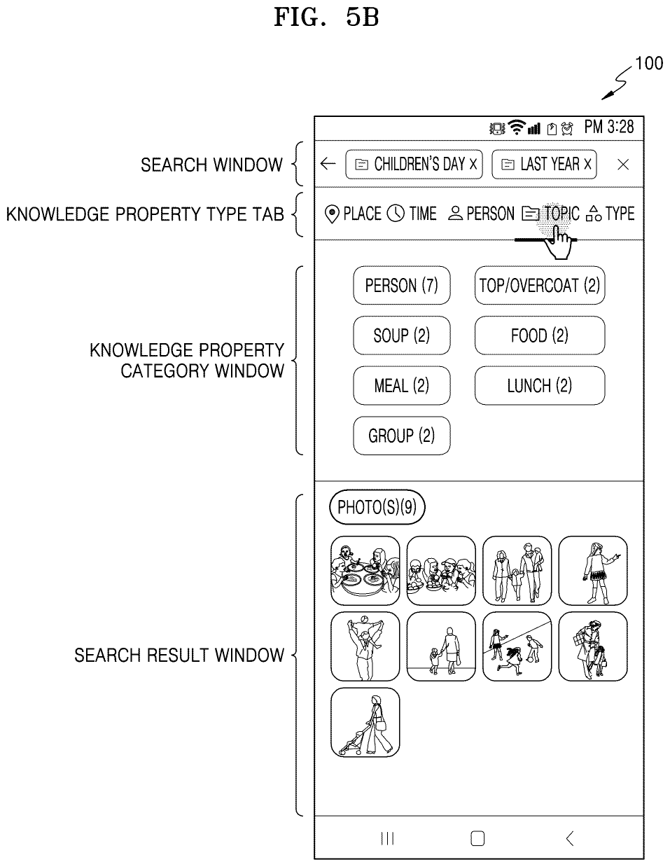

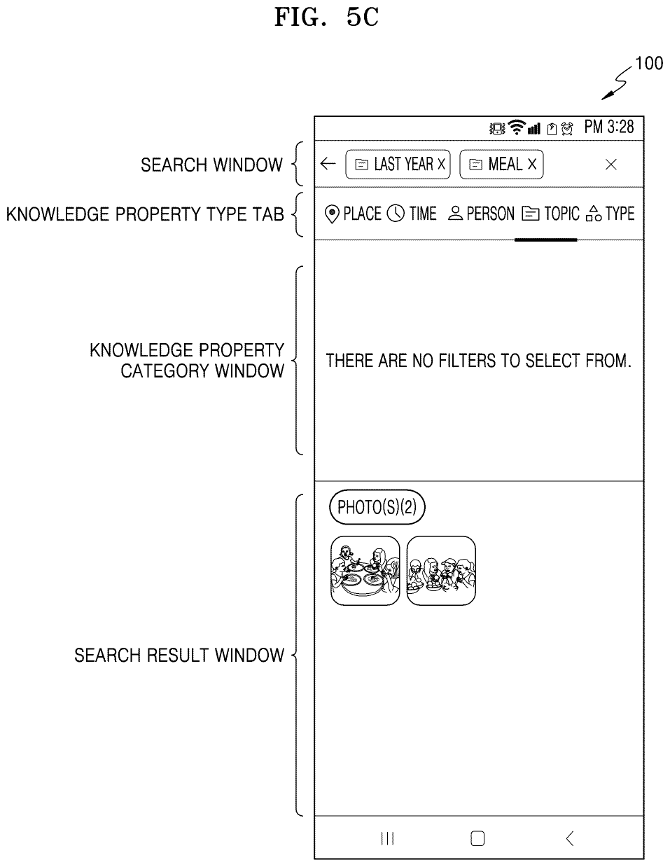

FIGS. 5A, 5B, and 5C are diagrams illustrating a process performed by the user device 100 to search for a photo by using a search term based on knowledge property information through a personal knowledge graph-based search application, according to an embodiment of the disclosure.

FIG. 5A illustrates a user interface screen (hereinafter, a “navigator”) of a personal knowledge graph-based search application. The navigator may include a search window, a knowledge property type tab, a knowledge property category window, and a search result window, and the positions, sizes, shapes, etc. thereof may be changed.

The search window may receive a user input regarding the search term. The user may directly input the search term by using a virtual keyboard overlapping a lower end of a screen, or may input the search term to the search window by selecting a related search term based on knowledge property information by using the knowledge property type tab and the knowledge property category window.

The knowledge property type tab may include a plurality of tabs separated by type of knowledge property information of each instance of the personal knowledge graph. Referring to FIG. 5A, the knowledge property type tab may include tabs corresponding to place, time, person, topic, and type for each type of the knowledge property information, but the disclosure is not limited thereto. For example, when the knowledge property information relates to the time when the content was captured, the corresponding instance may be classified as a time tab. The knowledge property type tab may be always displayed or may be displayed upon user interaction, depending on a user's settings, and may be provided in various ways, including drop-down, pop-up, new window, etc. A tab selected by the user among the plurality of tabs constituting the knowledge property type tab may be displayed so as to be distinct from other tabs.

The knowledge property category window may categorize knowledge property information of instances classified as each tab for each knowledge property type tab and provide information about the category names and the number of instances belonging to the corresponding category. The knowledge property information of the instance may be actual data values or information inferred from the actual data values. For example, when the knowledge property information of the instance is “wife,” the knowledge property information of the instance may be inferred and classified as “family.” When knowledge property information of a photo classified as each tab for each knowledge property type tab is not known, the user device 100 may infer candidate knowledge property information and use the inferred candidate knowledge property information, provide a thumbnail of the photo, or use the knowledge property type information as the knowledge property information.

A category name may be used as a search term. When the category name provided in the knowledge property category window is selected, the category name may be automatically input to the search window as a search term, and instances belonging to the corresponding category may be provided in the search result window. Referring to FIG. 5A, information about the category name and the number of instances belonging to the corresponding category may be expressed in the form of a term box, but the disclosure is not limited thereto, and the information may be provided in the form of a term cloud or a three-dimensional solid.

The knowledge property type tab and the knowledge property category window may be activated when the user inputs a search term, or may be activated without inputting a search term, based on a user's current specific action or predicted future action or certain context information.

The search result window may provide a search result corresponding to the search term input in the search window. Referring to FIG. 5A, in an embodiment of the disclosure in which photos are searched for through the personal knowledge graph-based search application, the search result window may provide thumbnails of photos corresponding to the search term and information about the total number of photos corresponding to the search term.

FIGS. 5A, 5B, and 5C are diagrams illustrating navigators in a process performed by the user device 100 to search for photos by using the search term based on the knowledge property information through the personal knowledge graph-based search application, according to an embodiment of the disclosure.

Referring to FIG. 5A, the user device 100 may receive a search term “Children's Day” from the user in the search window. The user device 100 may derive an IRI of the search term “Children's Day,” construct a query using the IRI of the search term “Children's Day,” and receive a query result for the personal knowledge graph based on the user content. The query result for the personal knowledge graph based on the user content may include a list of IRIs of 28 photos related to the IRI of “Children's Day,” type information of knowledge property information of the photos, knowledge property information of the photos classified as each tab for each knowledge property type tab, score information of each knowledge property information, information indicating that the type information of the content is a photo, etc. Referring to FIG. 5A, the user device 100 may display 28 photos in the search result window as the search result for “Children's Day,” categorize the knowledge property information of the photos classified as each tab for each knowledge property type tab in the knowledge property category window, and provide information about the category name and the number of photos belonging to the corresponding category. Referring to FIG. 5A, the knowledge property information of the photos classified as the time tab of the knowledge property type tab is categorized into “clear day,” “afternoon,” “last year,” “the year before last,” “morning,” “last month,” “this year,” and “OO month,” and information about the number of photos belonging to each category may be displayed in the knowledge property category window together with the category name. The category names, such as “clear day,” “afternoon,” “last year,” “the year before last,” “morning,” “last month,” “this year,” and “OO month” may be used as search terms that the user may associate with. When “last year” is selected from the category names provided in the knowledge property category window of FIG. 5A, “last year” may be additionally input as the search term in the search window and nine photos belonging to the “last year” category may be provided in the search result window, as illustrated in FIG. 5B. When the user selects the topic tab in the knowledge property type tab, knowledge property information of photos classified as the topic tab of the knowledge property type tab is categorized into “person,” “top/overcoat,” “soup,” “food,” “meal,” “lunch,” and “group” and information about the number of photos belonging to each category may be displayed in the knowledge property category window together with the category name, as illustrated in FIG. 5B. The category names, such as “person,” “top/overcoat,” “soup,” “food,” “meal,” “lunch,” and “group” may be used as search terms that the user may associate with. When “meal” is selected from the category names provided in the knowledge property category window of FIG. 5B, “meal” may be additionally input as the search term in the search window and two photos belonging to the “meal” category may be provided in the search result window, as illustrated in FIG. 5C.

On the other hand, when the user input for the search term is a multisearch term, for example, when “Children's Day” is received as the first search term and “last year” is received as the second search term, the user device 100 may obtain a query result of a query using an IRI corresponding to “Children's Day” and a query result of a query using an IRI corresponding to “last year” and then provide a result shown in FIG. 5B as a final result corresponding to the intersection of the respective query results.

As described above, the user device 100 may construct a query using the IRI corresponding to the search term input by the user and may search for a personal knowledge graph. The query may identify values of knowledge property information of instances constituting a personal knowledge graph and detect instances that have values corresponding to a search term. When there is an instance in which a value of knowledge property information is missing among the instances constituting the personal knowledge graph, it is impossible to identify whether the value corresponds to the search term, and thus, an appropriate instance may not be detected, or a result in which an instance to be actually detected is missing may be output. That is, to obtain good search results, it is important to know the values of knowledge property information of all instances constituting the personal knowledge graph. Therefore, it is necessary to manage the personal knowledge graph so that knowledge property information in which some or all of the values of the instances constituting the personal knowledge graph are missing (hereinafter, missing knowledge property information) is not present. Hereinafter, a method of managing a personal knowledge graph so that an instance including an incomplete node having missing knowledge property information is not present in a personal knowledge graph is described.

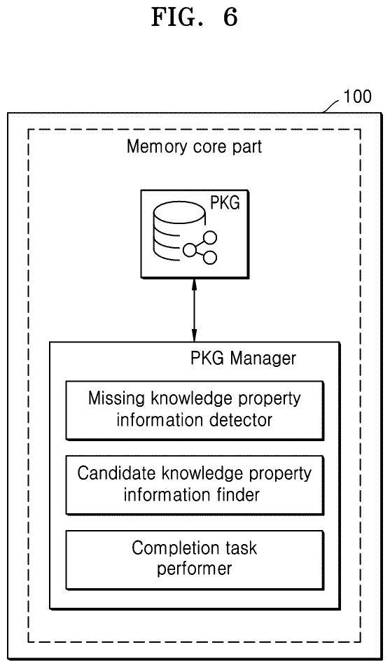

FIG. 6 is a diagram illustrating an operation performed by a user device 100 to manage a personal knowledge graph, according to an embodiment of the disclosure.

The user device 100 may manage a personal knowledge graph in a memory core part. The user device 100 may determine whether an instance constituting the personal knowledge graph has missing knowledge property information, identify whether the missing knowledge property information is improved, and fill the missing knowledge property information with an appropriate value. A personal knowledge graph manager may include a missing knowledge property information detector, a candidate knowledge property information detector, and a completion task performer.

The missing knowledge property information detector may determine whether the values of all pieces of knowledge property information of instances constituting the personal knowledge graph are complete without any omissions. When the value of at least one piece of knowledge property information of the instance is a null value, the missing knowledge property information detector may determine that there is the missing knowledge property information, and may determine that the knowledge property information of the instance is incomplete. When there is a missing value even when the value of knowledge property information of the instance is not a null value, the missing knowledge property information detector may determine that there is the missing knowledge property information, and may determine that the knowledge property information of the instance is incomplete. For example, when there are three people captured in a photo and data for only one of the three people is extracted to configure the value of knowledge property information about a person, the missing knowledge property information detector may determine that there are missing values for the remaining two people, and thus, may determine that knowledge property information about the person for the photo is incomplete. The missing knowledge property information detector may determine the presence or absence of missing knowledge property information according to whether the value of any knowledge property information is a null value, based on a graph data model, and may analyze the content itself and determine the presence or absence of missing knowledge property information according to the presence or absence of unidentified objects. The missing knowledge property information detector may detect an instance including an incomplete node having missing knowledge property information in the personal knowledge graph when the user is not using the user device 100 (e.g., when the user is sleeping or the user device 100 is charging) or when the user device 100 is completing a certain task.

When the instance including the incomplete node having the missing knowledge property information is detected, the candidate knowledge property information detector may identify candidate knowledge property information so as to improve the missing knowledge property information. The candidate knowledge property information detector may search for a complete node corresponding to the incomplete node in the personal knowledge graph and identify candidate knowledge property information corresponding to the missing knowledge property information in the complete node. Alternatively, the candidate knowledge property information detector may infer candidate knowledge property information corresponding to the missing knowledge property information.

The completion task performer may perform a task of completing the incomplete node. The completion task performer may perform the task of completing the incomplete node in response to a user input or when the accuracy of the candidate knowledge property information corresponding to the missing knowledge property information satisfies a certain condition. The completion task performer may replace the incomplete node with the found complete node when it is determined that the complete node found in the personal knowledge graph is identical to the incomplete node. When the incomplete node is replaced with the complete node, edges connected to the complete node may be connected to each other to form a contact point that may share knowledge property information between two pieces of content. When the completion task performer determines that the complete node found in the personal knowledge graph is not identical to the incomplete node, the completion task performer may update the missing knowledge property information of the incomplete node with the candidate knowledge property information identified in the found complete node. Alternatively, the completion task performer may update the missing knowledge property information of the incomplete node with the candidate knowledge property information inferred by the candidate knowledge property information detector. When the accuracy of the candidate knowledge property information is greater than or equal to a certain level, the completion task performer may automatically update the value of the missing knowledge property information of the instance including the incomplete node with the value of the candidate knowledge property information. Alternatively, the completion task performer may control the user device 100 to provide, to the user, a user interface that determines whether to update the value of the knowledge property information of the instance including the incomplete node with the value of the candidate knowledge property information, so as to update the missing knowledge property information. The completion task performer may control the user device 100 to provide a user interface that allows the user to directly input the value of the missing knowledge property information of the instance including the incomplete node. The completion task performer may update the missing knowledge property information based on a value of update approval or persistence property information input by the user.

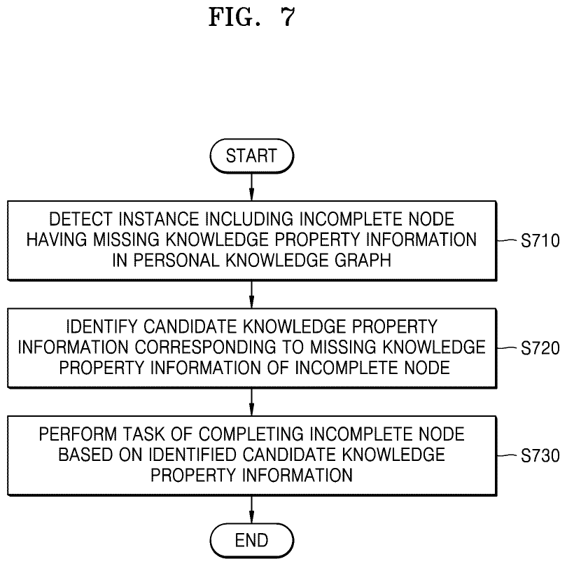

FIG. 7 is a flowchart showing a method of managing a personal knowledge graph, according to an embodiment of the disclosure.

Referring to FIG. 7, in operation S710, the user device 100 may detect an instance including an incomplete node having missing knowledge property information in the personal knowledge graph. The personal knowledge graph may be generated by using information obtained by the user device 100, and various types of personal knowledge graphs may be generated. For example, the personal knowledge graph based on user content may use nodes and edges to represent instances of photos or videos owned by the user, message information transmitted and received by the user, or content collected by using contact information. The incomplete node refers to a node in which a value of at least one piece of knowledge property information in a knowledge property information list defined in a class corresponding to the instance has a null value, or a node in which there is a missing value in some or all pieces of the knowledge property information even when the value of knowledge property information is not a null value. The user device 100 may determine whether the instance includes the incomplete node according to whether the value of any knowledge property information has a null value, based on a graph data model, or may analyze the content itself and determine whether the instance includes the incomplete node according to the presence or absence of unidentified objects.

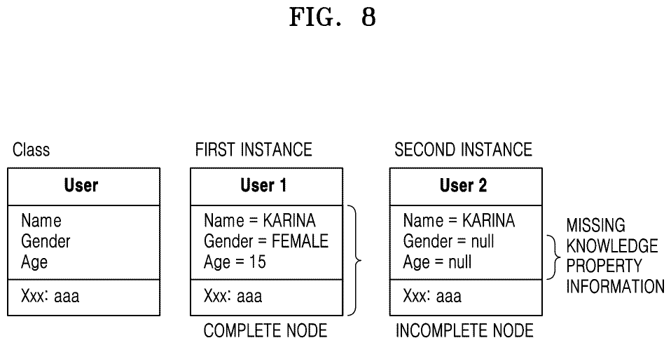

FIG. 8 is a diagram illustrating an instance including a complete node and an instance including an incomplete node having missing knowledge property information according to a certain class in a personal knowledge graph, according to an embodiment of the disclosure.

Referring to FIG. 8, a class for a user defines name, gender, and age as collectable data items. The collectable data items may be knowledge property information of an instance about a user. FIG. 8 illustrates an example in which a first instance corresponding to a first user and a second instance corresponding to a second user are generated by applying actual data values to data items defined in a class through data collection.

The first instance corresponding to the first user corresponds to a complete node because the first instance has knowledge property information of “Name=Karina,” “Gender=Female,” and “Age=15” and does not include any missing knowledge property information. On the other hand, the second instance corresponding to the second user corresponds to an incomplete node because the second instance has “Name=Karina” but has “Gender=null” and “Age=null as knowledge property information.”

Referring to FIG. 7, according to an embodiment of the disclosure, the user device 100 may determine a search category according to a user's behavior type for the personal knowledge graph. The user device 100 may differently determine the search category, such as whether to search only a portion of the personal knowledge graph or the entire personal knowledge graph, according to whether the user is sleeping, is resting, is using the user device 100, or is charging the user device 100. The search category corresponding to a user's behavior type may be determined by the length of search time or the number of search instances. The user device 100 may determine the presence or absence of an incomplete node having missing knowledge property information for each instance within the determined search category. For example, when the user is sleeping, sufficient time may be given to search the personal knowledge graph. Thus, the user device 100 may search for an instance including an incomplete node with respect to the entire personal knowledge graph. When the user is expected to use the user device 100 soon, only a short time may be given to search the personal knowledge graph. Thus, the user device 100 may search for an instance including an incomplete node only with respect to only a portion of the personal knowledge graph.

According to an embodiment of the disclosure, when the user device 100 detects a plurality of incomplete nodes in the personal knowledge graph, the user device 100 may assign the same tag if the missing knowledge property information included respectively in different incomplete nodes is the knowledge property information having the same value, and may assign different tags if the missing knowledge property information included respectively in different incomplete nodes is the knowledge property information having different values.

In operation S720, the user device 100 may identify candidate knowledge property information corresponding to the missing knowledge property information of the incomplete node. The user device 100 may search for or infer the candidate knowledge property information corresponding to the missing knowledge property information from the personal knowledge graph so as to find out a data value for the missing knowledge property information.

According to an embodiment of the disclosure, the user device 100 may search for a complete node corresponding to an incomplete node in the personal knowledge graph, based on a relationship between nodes in the personal knowledge graph and knowledge property information included in the incomplete node. The user device 100 may identify a node having a similar connection relationship to an incomplete node, based on a connection relationship between the incomplete node and other nodes in the personal knowledge graph. The user device 100 may identify nodes including the same knowledge property information, based on knowledge property information that knows the data value among a knowledge property information list included in the incomplete node. The user device 100 may search for a node determined to be identical to or most similar to the incomplete node in the personal knowledge graph, based on the relationship between nodes in the personal knowledge graph and the knowledge property information included in the incomplete node. When there is the instance including the incomplete node, the user device 100 may search for a complete node corresponding to the incomplete node through a graph embedding method based on graph information related to the incomplete node, an embedding method based on feature information of the instance, or a logic-based method capable of determining identity or similarity between nodes. The user device 100 may identify candidate knowledge property information corresponding to missing knowledge property information in the found complete node.

According to an embodiment of the disclosure, the user device 100 may infer the candidate knowledge property information corresponding to the missing knowledge property information, based on at least one of the graph information related to the incomplete node or the feature information of the instance. The user device 100 may obtain knowledge property information having a known data value from the knowledge property information list of the incomplete node having the missing knowledge property information. The user device 100 may obtain image feature information or text feature information by analyzing an image or text of the instance including the incomplete node.

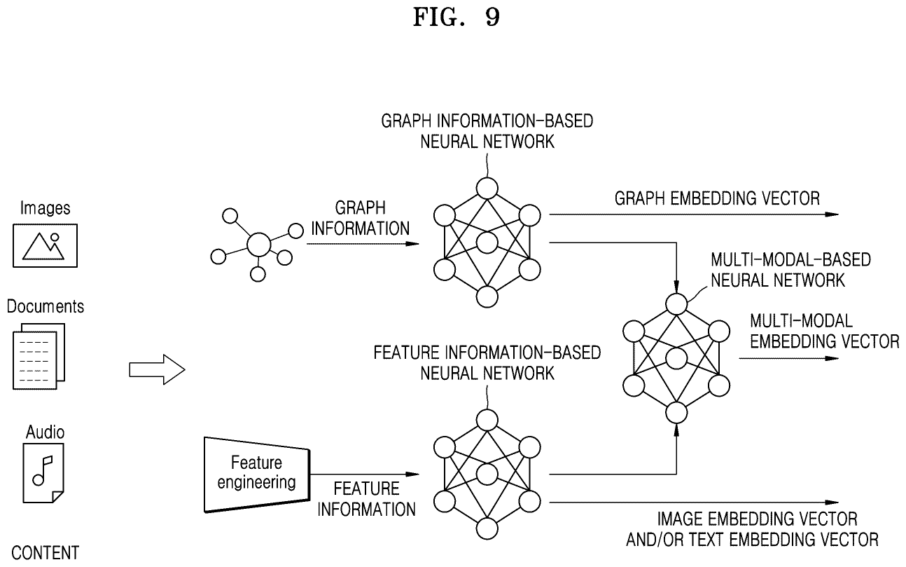

FIG. 9 is a diagram illustrating various types of embedding vectors used to infer candidate knowledge property information corresponding to missing knowledge property information, according to an embodiment of the disclosure.

When there is the instance including the incomplete node in the personal knowledge graph, the user device 100 may use a graph embedding vector, an image embedding vector, and/or a text embedding vector, and a multi-modal embedding vector to infer the candidate knowledge property information corresponding to the missing knowledge property information of the incomplete node.

Referring to FIG. 9, a graph information-based neural network may perform learning including information about ontology and instances, input graph information related to an incomplete node, and output a graph embedding vector. The graph information-based neural network may be a model in the form of a neural network including a plurality of layers.

A feature information-based neural network may receive feature information of an instance, for example, image feature information or text feature information, and output an image embedding vector and/or a text embedding vector. The image feature information may be information indicating features related to a shape, pattern, color, etc. that are identified from an image. The text feature information may be information indicating features related to the meaning of letters, numbers, symbols, etc. that may be identified from text. A feature information-based neural network may be a model in the form of a neural network including a plurality of layers.

A multi-modal-based neural network may output a multi-modal embedding vector by concatenating a graph embedding vector based on graph information related to an incomplete node and an image embedding vector and/or a text embedding vector of feature information of an instance. The graph embedding vector, which is the output of the graph information-based neural network, and the image embedding vectors and/or the text embedding vectors, which are/is the output of the feature information-based neural network, may be the input of the multi-modal-based neural network. The multi-modal embedding vector is an embedding vector generated by normalizing and concatenating embedding vectors of different modalities, and may reflect the features of the graph embedding vector, the image embedding vector, and/or the text embedding vector.

Referring again to FIG. 7, in an embodiment of the disclosure, the user device 100 may infer the candidate knowledge property information corresponding to the missing knowledge property information by using the graph embedding vector based on the graph information related to the incomplete node. For example, when knowledge property information about a person (author) who took photo “A” is missing knowledge property information, the user device 100 may infer candidate knowledge property information corresponding to the missing knowledge property information, based on a node of photo “B” clustered closest to an incomplete node of photo “A,” by using a graph embedding vector for a background or place extracted from photo A,” a graph embedding vector for a time when photo “A” was captured, etc. The user device 100 may infer candidate knowledge property information corresponding to the knowledge property information about the person who took photo “A” by extracting knowledge property information about a person who took photo “B” from the node of the photo “B.”

In an embodiment of the disclosure, the user device 100 may perform classification of instances by using the image embedding vector or the text embedding vector of the feature information of the instance, and infer candidate knowledge property information corresponding to missing knowledge property information. For example, when the knowledge property information about the time when photo “A” was taken is missing knowledge property information, the user device 100 may extract the background of photo “A” and generate an image embedding vector of the background, or may extract text about the time from photo “A” and generate a text embedding vector. The user device 100 may compare the generated image embedding vector or text embedding vector with the embedding vector for each time zone, classify the time zone in which photo “A” was taken, and infer candidate knowledge property information corresponding to the knowledge property information for the time when photo “A” was taken.

In an embodiment of the disclosure, the user device 100 may infer candidate knowledge property information corresponding to missing knowledge property information by using the multi-modal embedding vector based on the graph embedding vector based on the graph information related to the incomplete node and the image embedding vector or the text embedding vector of the feature information of the instance. For example, when the knowledge property information about the place where photo “A” was taken is missing knowledge property information, the user device 100 may use the multi-modal embedding vector in which the graph embedding vector based on the knowledge property information about the time when photo “A” was taken and the image embedding vector for the person or background extracted through image analysis of photo “A” are concatenated. The user device 100 may use the multi-modal embedding vector to extract knowledge property information about the place where photo “A” was taken from a photo that includes the same person or background as photo “A” and was taken at a similar time as the time when photo “A” was taken, and infer candidate knowledge property information about the place where photo “A” was taken. For example, when the knowledge property information about the place where photo “A” was taken is missing knowledge property information, the user device 100 may use the multi-modal embedding vector in which the graph embedding vector based on the knowledge property information about the time when photo “A” was taken and the text embedding vector for text extracted through text analysis of photo “A” are concatenated. The user device 100 may use the multi-modal embedding vector to extract knowledge property information about the place where photo “A” was taken from a photo that includes the same text as the text extracted from photo “A” and was taken at a similar time as the time when photo “A” was taken, and infer candidate knowledge property information about the place where photo “A” was taken.

In operation S730, the user device 100 may perform a task of completing an incomplete node based on the identified candidate knowledge property information.

According to an embodiment of the disclosure, the user device 100 may perform the task of completing the incomplete node in response to a user input or when the accuracy of the candidate knowledge property information corresponding to the missing knowledge property information satisfies a certain condition. For example, the user device 100 may perform the task of completing the incomplete node automatically or through a user input based on the accuracy of the candidate knowledge property information. When the accuracy of the candidate knowledge property information is less than a certain threshold value, the user device 100 may obtain an input of approval or modification from the user and then perform the task of completing the incomplete node based on the identified candidate knowledge property information. Alternatively, when the accuracy of the candidate knowledge property information is greater than or equal to the certain threshold value, the user device 100 may automatically perform the task of completing the incomplete node based on the identified candidate knowledge property information.

According to an embodiment of the disclosure, the user device 100 may search for a complete node corresponding to the incomplete node in the personal knowledge graph. When candidate knowledge property information corresponding to missing knowledge property information is identified in the found complete node, the user device 100 may determine whether the found complete node is identical to the incomplete node, and perform the task of completing the incomplete node based on a determination result. For example, the user device 100 may determine whether the found complete node is identical to the incomplete node by using key knowledge property information. Alternatively, the user device 100 may determine whether the found complete node is identical to the incomplete node by comprehensively comparing knowledge property information. When the user device 100 determines that the found complete node is identical to the incomplete node, the user device 100 may replace the incomplete node with the found complete node. When the user device 100 determines that the found complete node is not identical to the incomplete node, the user device 100 may update the missing knowledge property information with the candidate knowledge property information identified in the found complete node. The task of completing the incomplete node may be completed as the incomplete node is replaced with the complete node or as the missing knowledge property information is updated.

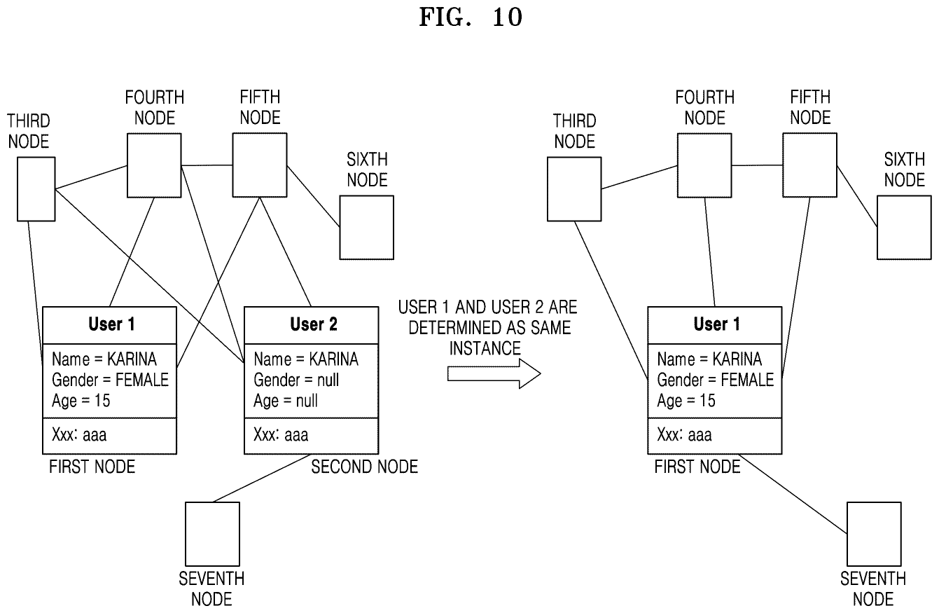

FIG. 10 is a diagram illustrating a process of performing a task of completing an incomplete node by replacing the incomplete node with a complete node, according to an embodiment of the disclosure.

Referring to FIG. 10, it may be confirmed that an instance corresponding to a first user is a first node, which is a complete node, and an instance corresponding to a second user is a second node, which is an incomplete node. Because the second node has “Name=Karina” but has “Gender=null” and “Age=null,” the second node includes missing knowledge property information, and thus, the second node is an incomplete node.

The user device 100 may search for a complete node corresponding to the second node, which is the incomplete node, in the personal knowledge graph and identify candidate knowledge property information corresponding to the missing knowledge property information in the first node, which is the found complete node. The user device 100 may determine whether the first node is identical to the second node, which is the incomplete node, and perform the task of completing the incomplete node according to a determination result. For example, the user device 100 may determine whether the first node is identical to the second node through an algorithm that determines the similarity of nodes on the knowledge graph, based on whether the first node and the second node have the same value or different values of key knowledge property information, a relationship with commonly connected nodes (a third node, a fourth node, and a fifth node), etc. When the first node is identical to the second node, which is the incomplete node, the user device 100 may delete the second node and replace the connection relationship for the second node with the first node.

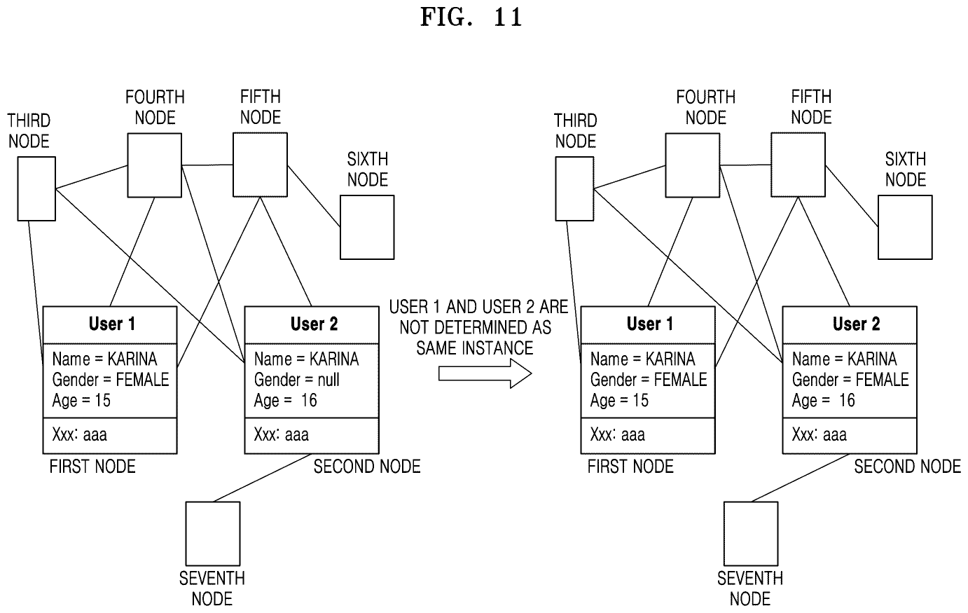

FIG. 11 is a diagram illustrating a process of performing a task of completing an incomplete node by identifying missing knowledge property information of an incomplete node in a complete node and then updating the missing knowledge property information of the incomplete node with candidate knowledge property information, according to an embodiment of the disclosure.

Referring to FIG. 11, it may be confirmed that an instance corresponding to a first user is a first node, which is a complete node, and an instance corresponding to a second user is a second node, which is an incomplete node. Because the second node has “Name=Karina” and “Age=16” but has “Gender=null,” the second node includes missing knowledge property information, and thus, the second node is an incomplete node.

The user device 100 may search for a complete node corresponding to the second node, which is the incomplete node, in the personal knowledge graph and identify candidate knowledge property information corresponding to the missing knowledge property information in the first node, which is the found complete node. The user device 100 may determine whether the first node is identical to the second node, which is the incomplete node, and perform the task of completing the incomplete node according to a determination result. In the case of FIG. 11, because the first node has the name of the same value as the second node as the knowledge property information but has the age of a value different from the second node, the user device 100 may determine that the first node is not identical to the second node. The user device 100 may update “Gender,” which is the missing knowledge property information in the second node, with candidate knowledge property information identified in the first node. To update the missing knowledge property information, the user device 100 may provide a user interface that allows the user to identify whether to update the value of the missing knowledge property information of the instance including the incomplete node with the value of the candidate knowledge property information, or a user interface that allows the user to directly input the value of the missing knowledge property information, and may receive the value of the update approval or persistent property information from the user in response thereto. Referring again to FIG. 7, according to an embodiment of the disclosure, when the user device 100 infers the candidate knowledge property information corresponding to the missing knowledge property information, the user device 100 may update the missing knowledge property information with the inferred candidate knowledge property information. As the missing knowledge property information is updated, the task of completing the incomplete node may be completed.

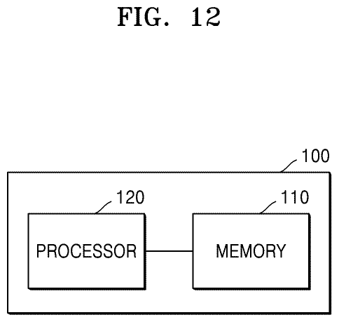

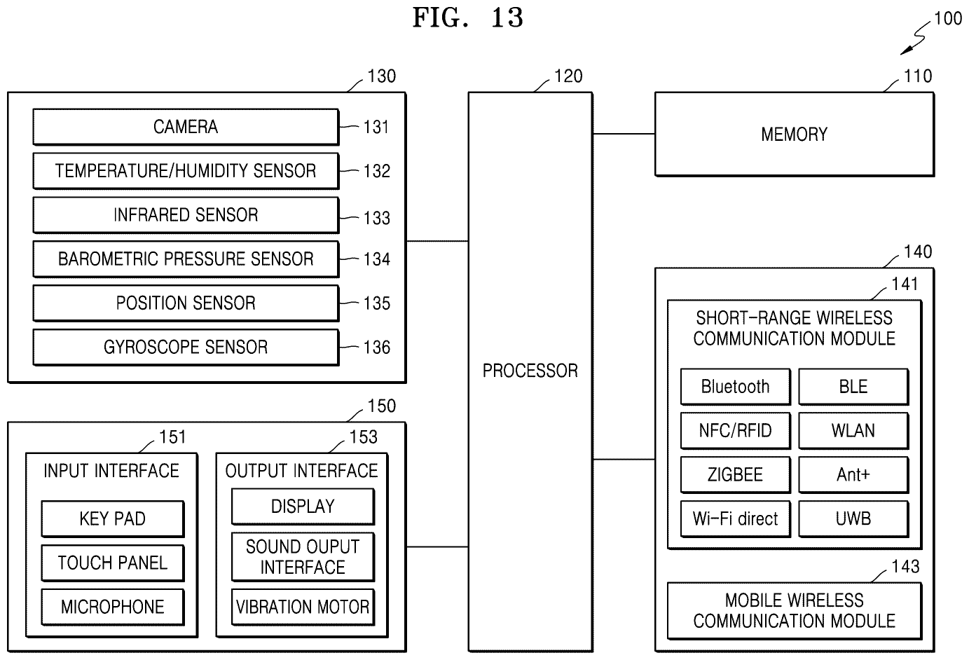

FIG. 12 is a block diagram illustrating the user device 100 according to an embodiment of the disclosure. FIG. 13 is a block diagram illustrating a configuration and an operation of the user device 100 according to an embodiment of the disclosure.

Referring to FIG. 12, the user device 100 according to an embodiment of the disclosure may include memory 110 and a processor 120, but the disclosure is not limited thereto, and a general-purpose configuration may be further added. For example, as illustrated in FIG. 13, the user device 100 may further include, in addition to the memory 110 and the processor 120, a sensing module 130, a communication module 140, and an input/output interface 150. Hereinafter, the respective elements are described in detail with reference to FIGS. 12 and 13.

The memory 110 according to an embodiment of the disclosure may store a program for processing and control by the processor 120 and may store data and information input to or generated from the user device 100. The memory 110 may store instructions, a data structure, and program code, which are readable by the processor 120. Operations performed by the processor 120 may be implemented by executing instructions or program codes stored in the memory 110.

The memory 110 according to an embodiment of the disclosure may include flash memory-type memory, hard disk-type memory, multimedia card micro-type memory, or card-type memory (e.g., secure digital (SD) or extreme digital (XD) memory), may include a non-volatile memory including at least one of read-only memory (ROM), electrically erasable programmable read-only memory (EEPROM), programmable read-only memory (PROM), magnetic memory, magnetic disc, or optical disc, and may include a volatile memory, such as random access memory (RAM) or static random access memory (SRAM).

The memory 110 according to an embodiment of the disclosure may store one or more instructions and/or programs that control the user device 100 to train a neural network model or utilize a neural network model.

The processor 120 according to an embodiment of the disclosure may execute instructions or programmed software modules stored in the memory 110 to control operations or functions so that the user device 100 may perform tasks. The processor 120 may include hardware components that perform arithmetic, logic, and input/output operations and signal processing. The processor 120 may execute one or more instructions stored in the memory 110 to control the overall operation of the user device 100. The processor 120 may execute programs stored in the memory 110 to control the sensing module 130 including at least one sensor, the communication module 140, and the input/output interface 150.

The processor 120 may include various processing circuitries and/or a plurality of processors. For example, the term “processor” as used herein, including the claims, may include various processing circuitries including at least one processor. “At least one processor” may be individually and/or collectively configured to perform various functions described herein. As used herein, the “processor,” “at least one processor,” and “one or more processors” may be configured to perform various functions. However, these terms may cover, without limitation, a situation where one processor performs some functions and other processor(s) perform other functions, and a situation where a single processor may perform all the functions. In addition, the “at least one processor” may include a combination of processors that perform the disclosed various functions in a distributed manner. The “at least one processor” may execute program instructions to accomplish or perform various functions.

The processor 120 according to an embodiment of the disclosure may include, for example, at least one of a CPU, a microprocessor, a GPU, an application specific integrated circuit (ASIC), a DSP, a digital signal processing device (DSPD), a programmable logic device (PLD), a field programmable gate array (FPGA), an AP, an NPU, or a dedicated AI processor designed with a hardware structure specialized for processing an AI model, but the disclosure is not limited thereto. Each processor constituting the processor 120 may be a dedicated processor that performs a certain function.

The AI processor according to an embodiment of the disclosure may use an AI model to perform calculation and control to process a task set to be performed by the user device 100. The AI processor may be manufactured in the form of a dedicated hardware chip for AI, or may be manufactured as part of a general-purpose processor (e.g., a CPU or an AP) or a GPU and mounted on the user device 1.

The sensing module 130 according to an embodiment of the disclosure may include a plurality of sensors configured to sense information about the surrounding environment of the user device 100. For example, the sensing module 130 may include a camera 131, a temperature/humidity sensor 132, an infrared sensor 133, a barometric pressure sensor 134, a position sensor 135, a gyroscope sensor 136, or the like, but the disclosure is not limited thereto. Because the functions of the sensors may be intuitively inferred from the names of the sensors by those of ordinary skill in the art, the functions of the sensors are briefly described below.

The camera 131 according to an embodiment of the disclosure may include a stereo camera, a mono camera, a wide-angle camera, an around-view camera, or a three-dimensional (3D) vision sensor. The temperature/humidity sensor 132 may measure a temperature or humidity of a position where the user device 100 is located. The infrared sensor 133 may be an active infrared sensor that senses a change by radiating infrared light and blocking the light, or a passive infrared sensor that does not have a light emitter and only senses a change in infrared light received from the outside. The barometric pressure sensor 134 may measure a barometric pressure at a position where the user device 100 is located. The position sensor 135 may detect the position of the user device 100. For example, the position sensor 135 may be a global positioning system (GPS). The gyroscope sensor 136 may detect angular velocity. The gyroscope sensor 136 may be used to measure the position of the user device 100 and set the moving direction of the user device 100.

The communication module 140 may include one or more components that enable the user device 100 to communicate with an external device, for example, a server or other electronic devices. For example, the communication module 140 may include a short-range wireless communication module 141, a mobile wireless communication module 143, or the like, but the disclosure is not limited thereto.

The short-range wireless communication module 141 may include a Bluetooth communication module, a Bluetooth Low Energy (BLE) communication module, a Near Field Communication (NFC) communication module, a wireless local area network (WLAN) (Wi-Fi™) communication module, a ZigBee communication module, an Ant+ communication module, a Wi-Fi Direction (WFD) communication module, an Ultra-Wideband (UWB) communication module, an Infrared Data Association (IrDA) communication module, a micro wave (uWave) communication module, or the like, but the disclosure is not limited thereto.

The mobile wireless communication module 143 may transmit and receive radio signals to and from at least one of a base station, an external terminal, or a server on a mobile communication network. The radio signals may include voice call signals, video call signals, or various types of data according to text/multimedia message transmission and reception.

The input/output interface 150 may include an input interface 151 and an output interface 153. In the input/output interface 150, the input interface 151 and the output interface 153 may be provided in a separated form or may be provided in an integrated form, such as a touch screen. The input/output interface 150 may receive input information from the user and provide output information to the user.

The input interface 151 may refer to a means for allowing the user to input data for controlling the user device 100. For example, the input interface 151 may include a key pad, a touch panel (a contact capacitance type touch panel, a pressure resistance film type touch panel, an infrared detection type touch panel, a surface ultrasonic conduction type touch panel, an integral tension measurement type touch panel, a piezo effect type touch panel, etc.), or a microphone, but the disclosure is not limited thereto. In addition, the input interface 151 may include a jog wheel, a jog switch, or the like, but the disclosure is not limited thereto.

The output interface 153 may output an audio signal, a video signal, or a vibration signal, and the output interface 153 may include a display, a sound output interface, and a vibration motor. The display may display information processed by the user device 100. For example, the display may display a user interface that receives a user's manipulation. When the display and a touch pad are configured as a touch screen having a layer structure, the display may be used as an input device as well as an output device. The display may include at least one of a liquid crystal display, a thin-film transistor-liquid crystal display, an organic light-emitting diode, a flexible display, or a 3D display. The user device 100 may include two or more display according to the implementation mode of the user device 100. The sound output interface may output audio data stored in the memory 110. The sound output interface may output sound signals related to the functions performed by the user device 100. The sound output interface may include a speaker, a buzzer, or the like.

The user device 100 according to an embodiment of the disclosure may include the memory 110 storing at least one instruction and at least one processor 120 operatively connected to the memory 110 to execute the at least one instruction. The at least one processor 120 may execute the at least one instruction to load and execute instructions or code for a certain module.

The processor 120 of the user device 100 according to an embodiment of the disclosure may execute the at least one instructions to control the user device 100 so that the operation of the user device 100 described above with reference to the drawings may be performed.

The processor 120 of the user device 100 according to an embodiment of the disclosure may execute the at least one instruction to detect an instance including an incomplete node having missing knowledge property information in a personal knowledge graph. The personal knowledge graph may be generated by using information obtained by the user device 100, and various types of personal knowledge graphs may be generated. For example, the personal knowledge graph based on user content may use nodes and edges to represent instances of content collected by using photos or videos owned by the user, message information transmitted and received by the user, or contact information. The incomplete node refers to a node in which a value of at least one piece of knowledge property information in a knowledge property information list defined in a class corresponding to the instance has a null value, or a node in which there is a missing value in some or all pieces of the knowledge property information even when the value of knowledge property information is not a null value.

According to an embodiment of the disclosure, the processor 120 may determine a search category according to a user's behavior type for the personal knowledge graph. For example, the processor 120 may analyze the user's behavior type and differently determine the search category, that is, whether to search only a portion of the personal knowledge graph or search for the entire personal knowledge graph, according to the analyzed behavior type. The search category corresponding to the user's behavior type may be predefined. The search category corresponding to the user's behavior type may be determined by the length of search time or the number of search instances. The processor 120 may determine the presence or absence of an incomplete node having missing knowledge property information for each instance within the determined search category.

According to an embodiment of the disclosure, when the processor 120 detects a plurality of incomplete nodes in the personal knowledge graph, the processor 120 may assign the same tag when the missing knowledge property information included in different incomplete nodes is the knowledge property information having the same value, and may assign different tags when the missing knowledge property information is the knowledge property information having different values.

The processor 120 may execute the at least one instruction to identify candidate knowledge property information corresponding to the missing knowledge property information of the incomplete node. The processor 120 may search for or infer the candidate knowledge property information corresponding to the missing knowledge property information from the personal knowledge graph so as to find out a data value for the missing knowledge property information.

According to an embodiment of the disclosure, the processor 120 may search for a complete node corresponding to an incomplete node in the personal knowledge graph, based on a relationship between nodes in the personal knowledge graph and knowledge property information included in the incomplete node. The processor 120 may identify a node having a similar connection relationship to an incomplete node, based on a connection relationship between the incomplete node and other nodes in the personal knowledge graph. The processor 120 may identify nodes including the same knowledge property information, based on knowledge property information that knows the data value among a knowledge property information list included in the incomplete node. The processor 120 may search for a node determined to be identical to or most similar to the incomplete node in the personal knowledge graph, based on the relationship between nodes in the personal knowledge graph and the knowledge property information included in the incomplete node. The processor 120 may identify candidate knowledge property information corresponding to missing knowledge property information in the found complete node.

According to an embodiment of the disclosure, the processor 120 may infer the candidate knowledge property information corresponding to the missing knowledge property information, based on at least one of the graph information related to the incomplete node or the feature information of the instance. The processor 120 may obtain knowledge property information having a known data value from the knowledge property information list of the incomplete node having the missing knowledge property information. The processor 120 may obtain image feature information or text feature information by analyzing an image or text of the instance including the incomplete node.

According to an embodiment of the disclosure, the processor 120 may infer the candidate knowledge property information corresponding to the missing knowledge property information by using a graph embedding vector based on graph information related to the incomplete node. For example, when first knowledge property information is missing knowledge property information, the processor 120 may infer candidate knowledge property information corresponding to the first knowledge property information, which is the missing knowledge property information, based on a node clustered closest to the incomplete node including the missing knowledge property information, by using a graph embedding vector for second knowledge property information, a graph embedding vector for third knowledge property information, and the like. The processor 120 may infer the candidate knowledge property information corresponding to the first knowledge property information by extracting knowledge property information corresponding to the first knowledge property information from the node clustered closest to the incomplete node.

According to an embodiment of the disclosure, the processor 120 may perform classification of instances by using the image embedding vector or the text embedding vector of the feature information of the instance, and infer candidate knowledge property information corresponding to missing knowledge property information. For example, when the first knowledge property information is the missing knowledge property information, the processor 120 may extract a background from the instance as feature information and generate an image embedding vector of the background, or may extract text from the instance as feature information and generate a text embedding vector. The processor 120 may infer the candidate knowledge property information corresponding to the first knowledge property information by using the generated image embedding vector or text embedding vector to classify the attributes of the instance.

According to an embodiment of the disclosure, the processor 120 may infer the candidate knowledge property information corresponding to the missing knowledge property information by using the multi-modal embedding vector based on the graph embedding vector based on the graph information related to the incomplete node and the image embedding vector of the feature information of the instance. For example, when the first knowledge property information is the missing knowledge property information, the processor 120 may infer the candidate knowledge property information corresponding to the first knowledge property information by using the multi-modal embedding vector in which the graph embedding vector of the second knowledge property information and the image embedding vector for the person or background extracted through image analysis are concatenated.

According to an embodiment of the disclosure, the processor 120 may infer the candidate knowledge property information corresponding to the missing knowledge property information by using the multi-modal embedding vector based on the graph embedding vector based on the graph information related to the incomplete node and the text embedding vector of the feature information of the instance. For example, when the first knowledge property information is the missing knowledge property information, the processor 120 may infer the candidate knowledge property information corresponding to the first knowledge property information by using the multi-modal embedding vector in which the graph embedding vector of the second knowledge property information and the text embedding vector extracted through text analysis are concatenated.

The processor 120 may execute the at least one instruction to perform the task of completing the incomplete node based on the identified candidate knowledge property information.

According to an embodiment of the disclosure, the processor 120 may search for a complete node corresponding to the incomplete node in the personal knowledge graph. When candidate knowledge property information corresponding to missing knowledge property information is identified in the found complete node, the processor 120 may determine whether the found complete node is identical to the incomplete node, and perform the task of completing the incomplete node based on a determination result. For example, the processor 120 may determine whether the found complete node is identical to the incomplete node by using key knowledge property information. Alternatively, the processor 120 may determine whether the found complete node is identical to the incomplete node by comprehensively comparing knowledge property information. When the processor 120 determines that the found complete node is identical to the incomplete node, the processor 120 may replace the incomplete node with the found complete node. When the processor 120 determines that the found complete node is not identical to the incomplete node, the processor 120 may update the missing knowledge property information with the candidate knowledge property information identified in the found complete node. The task of completing the incomplete node may be completed as the incomplete node is replaced with the complete node or as the missing knowledge property information is updated.

According to an embodiment of the disclosure, when the processor 120 infers the candidate knowledge property information corresponding to the missing knowledge property information, the processor 120 may update the missing knowledge property information with the inferred candidate knowledge property information. As the missing knowledge property information is updated, the task of completing the incomplete node may be completed.

According to an embodiment of the disclosure, the processor 120 may perform the task of completing the incomplete node in response to a user input or when the accuracy of the candidate knowledge property information corresponding to the missing knowledge property information satisfies a certain condition. For example, the processor 120 may perform the task of completing the incomplete node automatically or through user confirmation, based on the accuracy of the candidate knowledge property information. When the accuracy of the candidate knowledge property information is less than a certain threshold value, the processor 120 may obtain an input of approval or modification from the user through the input/output interface 150 and then perform the task of completing the incomplete node based on the identified candidate knowledge property information. Alternatively, when the accuracy of the candidate knowledge property information is greater than or equal to the certain threshold value, the processor 120 may automatically perform the task of completing the incomplete node based on the identified candidate knowledge property information.

On the other hand, the embodiment of the disclosure may be implemented in the form of a computer-readable recording medium including computer-executable instructions, such as program modules executable by a computer. A computer-readable recording medium may be any available media that are accessible by the computer and may include any volatile and non-volatile media and any removable and non-removable media. In addition, the computer-readable recording medium may include a computer storage medium and a communication medium. The computer storage medium may include any volatile, non-volatile, removable, and non-removable media that are implemented in any method or technology for storage of information, such as computer-readable instructions, data structures, program modules, or other data. The communication medium may typically include computer-readable instructions, data structures, or other data of a modulated data signal, such as program modules.

Also, the computer-readable recording medium may be provided in the form of a non-transitory computer-readable recording medium. The ‘non-transitory storage medium’ is a tangible device and only means not including a signal (e.g., electromagnetic waves). This term does not distinguish between a case where data is semi-permanently stored in a storage medium and a case where data is temporarily stored in a storage medium. For example, the ‘non-transitory storage medium’ may include a buffer in which data is temporarily stored.

The method according to an embodiment of the disclosure may be provided by being included in a computer program product. The computer program product may be traded between a seller and a buyer as commodities. The computer program product may be distributed in the form of a machine-readable storage medium (e.g., compact disc read-only memory (CD-ROM)), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or memory of a relay server, or may be temporarily generated.

According to an embodiment of the disclosure, a computer-readable recording medium having recorded thereon a program for causing a computer to perform a method of constructing a personal knowledge graph in a user device, a method of providing a service by using a personal knowledge graph, or a method of managing a personal knowledge graph is provided.

According to an embodiment of the disclosure, a method of managing a personal knowledge graph is provided. The method may include detecting an instance including an incomplete node having missing knowledge property information in a personal knowledge graph in operation S710. In addition, the method may include identifying candidate knowledge property information corresponding to the missing knowledge property information of the incomplete node in operation S720. In addition, the method may include performing a task of completing the incomplete node based on the identified candidate knowledge property information in operation S730.

In addition, according to an embodiment of the disclosure, the identifying of the candidate knowledge property information in operation S720 may include searching for a complete node corresponding to the incomplete node in the personal knowledge graph, based on a relationship between nodes in the personal knowledge graph and knowledge property information included in the incomplete node. In addition, the identifying of the candidate knowledge property information in operation S720 may include identifying the candidate knowledge property information corresponding to the missing knowledge property information in the searched complete node.

In addition, the performing of the task of completing the incomplete node in operation S730 may include determining whether the searched complete node is identical to the incomplete node. In addition, the performing of the task of completing the incomplete node in operation S730 may include replacing the incomplete node with the searched complete node if it is determined that the searched complete node is identical to the incomplete node, and updating the missing knowledge property information with the candidate knowledge property information identified in the searched complete node if it is determined that the searched complete node is not identical to the incomplete node.

In addition, according to an embodiment of the disclosure, the identifying of the candidate knowledge property information in operation S720 may include inferring the candidate knowledge property information corresponding to the missing knowledge property information, based on at least one of graph information related to the incomplete node or feature information of the instance.

In addition, the inferring of the candidate knowledge property information may include inferring the candidate knowledge property information corresponding to missing knowledge property information by using a multi-modal embedding vector based on a graph embedding vector based on the graph information related to the incomplete node and an image embedding vector or a text embedding vector of the feature information of the instance.

In addition, the performing of the task of completing the incomplete node in operation S730 may include updating the missing knowledge property information with the inferred candidate knowledge property information.

In addition, according to an embodiment of the disclosure, the performing of the task of completing the incomplete node in operation S730 may include performing the task of completing the incomplete node in response to a user input or when accuracy of the candidate knowledge property information corresponding to the missing knowledge property information satisfies a certain condition.

In addition, according to an embodiment of the disclosure, the detecting of the instance including the incomplete node in operation S710 may include determining a search category according to a user's behavior type for the personal knowledge graph. In addition, the detecting of the instance including the incomplete node in operation S710 may include determining a presence or absence of the incomplete node having the missing knowledge property information for each instance within the determined search category.

In addition, according to an embodiment of the disclosure, the detecting of the instance including the incomplete node in operation S710 may further include assigning a same tag if missing knowledge property information included respectively in different incomplete nodes is knowledge property information having a same value, and assigning different tags if missing knowledge property information included respectively in different incomplete nodes is knowledge property information having different values.

In addition, according to an embodiment of the disclosure, a computer-readable recording medium having recorded thereon a program for causing a computer to perform the method of managing a personal knowledge graph is provided.

In addition, according to an embodiment of the disclosure, a user device 100 for managing a personal knowledge graph is provided. The user device 100 may include memory 110 including one or more storage media storing at least one instruction and at least one processor 120 including a processing circuit. In addition, the at least one processor 120 may be configured to execute the at least one instruction to detect an instance including an incomplete node having missing knowledge property information in a personal knowledge graph. In addition, the at least one processor 120 may be further configured to execute the at least one instruction to identify candidate knowledge property information corresponding to the missing knowledge property information of the incomplete node. In addition, the at least one processor 120 may be further configured to execute the at least one instruction to perform a task of completing the incomplete node based on the identified candidate knowledge property information.

In addition, according to an embodiment of the disclosure, the at least one processor 120 may be further configured to execute the at least one instruction to search for a complete node corresponding to the incomplete node in the personal knowledge graph, based on a relationship between nodes in the personal knowledge graph and knowledge property information included in the incomplete node. In addition, the at least one processor 120 may be further configured to identify the candidate knowledge property information corresponding to the missing knowledge property information in the searched complete node.

In addition, the at least one processor 120 may be further configured to execute the at least one instruction to determine whether the searched complete node is identical to the incomplete node. In addition, the at least one processor 120 may be further configured to execute the at least one instruction to replace the incomplete node with the searched complete node if it is determined that the searched complete node is identical to the incomplete node and update the missing knowledge property information with the candidate knowledge property information identified in the searched complete node if it is determined the searched complete node is not identical to the incomplete node.

In addition, according to an embodiment of the disclosure, the at least one processor 120 may be further configured to execute the at least one instruction to infer the candidate knowledge property information corresponding to the missing knowledge property information, based on at least one of graph information related to the incomplete node or feature information of the instance.

In addition, the at least one processor 120 may be further configured to execute the at least one instruction to infer the candidate knowledge property information corresponding to missing knowledge property information by using a multi-modal embedding vector based on a graph embedding vector based on the graph information related to the incomplete node and an image embedding vector or a text embedding vector of the feature information of the instance.

In addition, the at least one processor 120 may be further configured to execute the at least one instruction to perform classification of the instance by using an image embedding vector or a text embedding vector of the feature information of the instance and infer the candidate knowledge property information corresponding to the missing knowledge property information.

In addition, the at least one processor 120 may be further configured to execute the at least one instruction to update the missing knowledge property information with the inferred candidate knowledge property information.

In addition, according to an embodiment of the disclosure, the at least one processor 120 may be further configured to execute the at least one instruction to perform the task of completing the incomplete node in response to a user input or when accuracy of the candidate knowledge property information corresponding to the missing knowledge property information satisfies a certain condition.

In addition, according to an embodiment of the disclosure, the at least one processor 120 may be further configured to execute the at least one instruction to determine a search category according to a user's behavior type for the personal knowledge graph. In addition, the at least one processor 120 may be further configured to execute the at least one instruction to determine a presence or absence of the incomplete node having the missing knowledge property information for each instance within the determined search category.

In addition, according to an embodiment of the disclosure, the at least one processor 120 may be further configured to execute the at least one instruction to assign a same tag if missing knowledge property information included respectively in different incomplete nodes is knowledge property information having a same value and assign different tags if missing knowledge property information included respectively in different incomplete nodes is knowledge property information having different values.

The foregoing description of the disclosure is for illustrative purposes only, and those of ordinary skill in the art to which the disclosure pertains will understand that modifications into other specific forms may be made thereto without changing the technical spirit or essential features of the disclosure. Therefore, it should be understood that the embodiments of the disclosure described above are illustrative in all aspects and are not restrictive. For example, the components described as being singular may be implemented in a distributed manner. Similarly, the components described as being distributed may be implemented in a combined form.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device for managing a personal knowledge graph, the method comprising:
detecting, by the electronic device, an instance including an incomplete node having missing knowledge property information in a personal knowledge graph;
identifying, by the electronic device, candidate knowledge property information corresponding to the missing knowledge property information of the incomplete node; and
performing, by the electronic device, a task of completing the incomplete node based on the identified candidate knowledge property information.

2. The method of claim 1, wherein the identifying of the candidate knowledge property information comprises:
searching for a complete node corresponding to the incomplete node in the personal knowledge graph, based on a relationship between nodes in the personal knowledge graph and knowledge property information included in the incomplete node; and
identifying the candidate knowledge property information corresponding to the missing knowledge property information in the searched complete node.

3. The method of claim 2, wherein the performing of the task of completing the incomplete node comprises:
determining whether the searched complete node is identical to the incomplete node;
replacing the incomplete node with the searched complete node if it is determined that the searched complete node is identical to the incomplete node; and
updating the missing knowledge property information with the candidate knowledge property information identified in the searched complete node if it is determined that the searched complete node is not identical to the incomplete node.

4. The method of claim 1, wherein the identifying of the candidate knowledge property information comprises inferring the candidate knowledge property information corresponding to the missing knowledge property information, based on at least one of graph information related to the incomplete node or feature information of the instance.

5. The method of claim 4, wherein the inferring of the candidate knowledge property information comprises inferring the candidate knowledge property information corresponding to missing knowledge property information by using a multi-modal embedding vector based on a graph embedding vector based on the graph information related to the incomplete node and an image embedding vector or a text embedding vector of the feature information of the instance.

6. The method of claim 4, wherein the performing of the task of completing the incomplete node comprises updating the missing knowledge property information with the inferred candidate knowledge property information.

7. The method of claim 1, wherein the performing of the task of completing the incomplete node comprises performing the task of completing the incomplete node in response to a user input or when accuracy of the candidate knowledge property information corresponding to the missing knowledge property information satisfies a certain condition.

8. The method of claim 1, wherein the detecting comprises:
determining a search category according to a user's behavior type for the personal knowledge graph; and
determining a presence or absence of the incomplete node having the missing knowledge property information for each instance within the determined search category.

9. The method of claim 1, wherein the detecting comprises:
assigning a same tag if missing knowledge property information included respectively in different incomplete nodes is knowledge property information having a same value; and
assigning different tags if missing knowledge property information included respectively in different incomplete nodes is knowledge property information having different values.

10. An electronic device comprising:
memory comprising one or more storage media storing instructions; and
one or more processors communicatively coupled to the memory,
wherein the instructions, when executed by the one or more processors individually or collectively, cause the electronic device to:
detect an instance including an incomplete node having missing knowledge property information in a personal knowledge graph,
identify candidate knowledge property information corresponding to the missing knowledge property information of the incomplete node, and
perform a task of completing the incomplete node based on the identified candidate knowledge property information.

11. The electronic device of claim 10, wherein the instructions, when executed by the one or more processors individually or collectively, further cause the electronic device to:
search for a complete node corresponding to the incomplete node in the personal knowledge graph, based on a relationship between nodes in the personal knowledge graph and knowledge property information included in the incomplete node, and
identify the candidate knowledge property information corresponding to the missing knowledge property information in the searched complete node.

12. The electronic device of claim 11, wherein the instructions, when executed by the one or more processors individually or collectively, further cause the electronic device to:
determine whether the searched complete node is identical to the incomplete node,
replace the incomplete node with the searched complete node if it is determined that the searched complete node is identical to the incomplete node, and
update the missing knowledge property information with the candidate knowledge property information identified in the searched complete node if it is determined that the searched complete node is not identical to the incomplete node.

13. The electronic device of claim 10, wherein the instructions, when executed by the one or more processors individually or collectively, further cause the electronic device to infer the candidate knowledge property information corresponding to the missing knowledge property information, based on at least one of graph information related to the incomplete node or feature information of the instance.

14. The electronic device of claim 13, wherein the instructions, when executed by the one or more processors individually or collectively, further cause the electronic device to infer the candidate knowledge property information corresponding to missing knowledge property information by using a multi-modal embedding vector based on a graph embedding vector based on the graph information related to the incomplete node and an image embedding vector or a text embedding vector of the feature information of the instance.

15. The electronic device of claim 13, wherein the instructions, when executed by the one or more processors individually or collectively, further cause the electronic device to:
perform classification of the instance by using an image embedding vector or a text embedding vector of the feature information of the instance, and
infer the candidate knowledge property information corresponding to the missing knowledge property information.

16. The electronic device of claim 13, wherein the instructions, when executed by the one or more processors individually or collectively, further cause the electronic device to update the missing knowledge property information with the inferred candidate knowledge property information.

17. The electronic device of claim 10, wherein the instructions, when executed by the one or more processors individually or collectively, further cause the electronic device to perform the task of completing the incomplete node in response to a user input or when accuracy of the candidate knowledge property information corresponding to the missing knowledge property information satisfies a certain condition.

18. The electronic device of claim 10, wherein the instructions, when executed by the one or more processors individually or collectively, further cause the electronic device to:
determine a search category according to a user's behavior type for the personal knowledge graph, and
determine a presence or absence of the incomplete node having the missing knowledge property information for each instance within the determined search category.

19. The electronic device of claim 10, wherein the instructions, when executed by the one or more processors individually or collectively, further cause the electronic device to:
assign a same tag if missing knowledge property information included respectively in different incomplete nodes is knowledge property information having a same value, and
assign different tags if missing knowledge property information included respectively in different incomplete nodes is knowledge property information having different values.

20. One or more non-transitory computer-readable storage media storing one or more computer programs including computer-executable instructions that, when executed by one or more processors of an electronic device individually or collectively, cause the electronic device to perform operations, the operations comprising:
detecting, by the electronic device, an instance including an incomplete node having missing knowledge property information in a personal knowledge graph;
identifying, by the electronic device, candidate knowledge property information corresponding to the missing knowledge property information of the incomplete node; and
performing, by the electronic device, a task of completing the incomplete node based on the identified candidate knowledge property information.
